(19) United States
(12) Patent Application Publication
(10) Pub. No.: US 2015/0242796 A1
(43) Pub. Date: Aug. 27, 2015

(54) RECOGITION EMAIL LISTENER

(71) Applicant: O.C. Tanner Company, Salt Lake City, UT (US)

(72) Inventors: David Hilton, North Salt Lake, UT (US); Zlatina Todorova, Salt Lake City, UT (US); Jason Andersen, Sandy, UT (US)

(21) Appl. No.: 14/631,197

(22) Filed: Feb. 25, 2015

Related U.S. Application Data
(60) Provisional application No. 61/945,058, filed on Feb. 26, 2014.

(51) Int. Cl. G06Q 10/06; H04L 12/58

(52) U.S. Cl. CPC G06Q 10/06398; H04L 51/34; H04L 51/22

(57) ABSTRACT

A system facilitates employee recognition and the analysis of performance indicators for evaluation of employee performance for users of email software by utilizing a plugin to the email software to direct emails containing recognition-related content into a predetermined mailbox. The plugin provides a check box on an email interface, the email-sending user automatically adds the address for the predetermined mailbox to the email interface bcc field by checking the check box. A recognition listener periodically loops through the emails within the predetermined mailbox gathering desired recognition-related information, such as the identity of an email-sending user, the identity of each recipient, and the textual content for each email. The recognition listener calls an application processing interface to facilitate further processing of the desired information. The application processing interface may interface with a recognition software platform to process the desired information by accumulating, categorizing, and presenting the desired information as processed.

### RELATED APPLICATION

This application claims the benefit of U.S. Provisional Application Ser. No. 61/945,058, entitled Recognition Email Listener, filed on Feb. 26, 2014.

This application has related subject matter to U.S. patent application Ser. No. ______ that was filed on the same day as this application and is entitled Strengths Recognition System. The aforementioned patent application and provisional patent application, in their entirety, are expressly incorporated into this application by this reference.

### BACKGROUND OF THE INVENTION

1. Field of the Invention

The present invention relates to systems and methods for directing emails that contain recognition content to a performance system for evaluation. More specifically, the present invention relates to a system and method for bringing the recognition software platform closer to the users by integrating a recognition listener plugin with the Microsoft Outlook® program (“Outlook”) or any other suitable email software system.

### BRIEF SUMMARY OF THE INVENTION

The system of the present invention has been developed in response to the present state of the art, and in particular, to facilitate employee recognition and the analysis of performance indicators for the evaluation of employee performance.

A recognition listener plugin allows email-sending users to automatically post employee recognition into a performance system using a plugin or adding a predetermined address into the “cc” field of an email.

The plugin to an email program such as Outlook® inserts a “recognition” check box into the email interface presented to an email-sending user. If the email-sending user checks the box by clicking on the box, the email-sending user is indicating that the content of the email has recognition-related content, such as praising an employee for work well done, for example, an award nomination, an eButton, or an eCard recognizing an employee's accomplishment. A copy of such recognition-related emails is sent to a predetermined mailbox for further processing.

Alternatively, if the recognition check box is not checked, the email-sending user may send a copy of the recognition-related email to the predetermined mailbox by adding the address for the predetermined mailbox into the “cc” or “bcc” field for the email.

The further processing may include aggregating recognitions by employee and providing members of company leadership with metrics related to the number and types of recognition. Certainly, any system that utilizes the information from the accumulated recognition-related emails may be used and is contemplated as providing backend processing by this disclosure. However, the recognition listener plugin is of particular interest to the O.C. Tanner recognition software platform and components thereof. An example of the type of backend processing that may be done is disclosed in the U.S. Provisional Patent Application No. 61/944,814, filed Feb. 26, 2014, entitled “Personal Strengths Recognition System”, and in U.S. patent application Ser. No. ______, titled “Strengths Recognition System”, and incorporated herein by this reference. By way of an example of backend processing, the strengths recognition system uses a skills finder feature with a skills finding search engine to extract recognition strengths from nomination, eCard, and other recognition-related email transactions using database functionality and data replication technology. The strengths recognition system aggregates the information by individual employee and presents the information on a web site, on a dashboard, or in email. Gathered data represents the individual employees' strengths and the number of times they have been recognized for them.

Every two minutes (or some other predetermined amount of time) a controller initiates a process that searches for new transactions to process through the skills finder feature and its skills finding search engine. When used by the system of the present invention, the skills finding search engine looks in the predetermined mailbox for emails to process. A temporary table of the mined information is created and indexed and the new transactions are inserted into that table. The strengths recognition system executes against the temporary table, aggregates the results by individual employee and populates a final aggregated table. The gathered data represents an employee's strengths and the number of times they have been recognized for those strengths. Such strengths can be associated with certain identifiable skills.

Highlighted skills can be displayed on dashboards for each individual employee as well as dashboards for members of the company leadership. Such displays are visual evidence of the recognition each individual employee has received, bolstering self-esteem, self-confidence, and employment loyalty. Additionally, such displays provide company leadership with an additional metric for evaluating employee performance for recognition and advancement.

The strengths recognition system uses a dictionary that comprises a predefined list of all strengths extractable by the skills finding search engine. The predefined dictionary is expandable to customize terminology for skills extraction. The dictionary comprises words and roots of those words attributable to strengths and the strengths are associated with one or more categories of skills. These identified skills are placed in a table, aggregated, and indexed. The table or another table is configured to provide the results of the extraction and the aggregation of the information into skills categories by team and/or individual, providing company management with a metric, not heretofore available, that relates to recognition and skills exhibited by an individual employee or a team of employees.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended figures. Understanding that these figures depict only exemplary embodiments of the invention and are not therefore to be considered to be limiting of its scope, the invention will be described and explained with additional specificity and detail through the use of the accompanying figures in which:

FIG. 1 is a schematic depiction of the high level architecture of an exemplary email listener system interfacing with a performance system that identifies employee skill sets and recognition;

FIG. 2 is a depiction of an exemplary screen shot of an email interface with a recognition check box and an address in the cc field; and

FIG. 3 is a depiction of an exemplary screen shot of an eCard as received by a recipient via email;

REFERENCE NUMERALS
recognition email listen system 10 (system 10)
performance system 11
email plugin 12
CC: field 14
BCC: field 16
plugin inbox 18
recognition listener 20
application processing interface 22 (API)
email interface 24
TO: field 26
body 28 (email body)
check box 30
address 32 (for plugin inbox)
send button 34
eCard 36

### DETAILED DESCRIPTION OF THE INVENTION

The presently preferred embodiments of the present invention will be best understood by reference to the appended figures. It will be readily understood that the components of the present invention, as generally described and illustrated in the figures herein, could be arranged and designed in a wide variety of different configurations. Thus, the following more detailed description of the exemplary embodiments of the present invention, as represented in the figures, is not intended to limit the scope of the invention, as claimed, but is merely representative of exemplary embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

The system of the present invention facilitates employee recognition and the analysis of performance indicators for the evaluation of employee performance. The system uses a recognition listener feature to listen for and gather recognition-related emails for further processing. In an exemplary embodiment of the system, the recognition listener feature allows email-sending users to automatically post employee recognition into a performance system using an email plugin or adding a predetermined address into the “cc” field of an email.

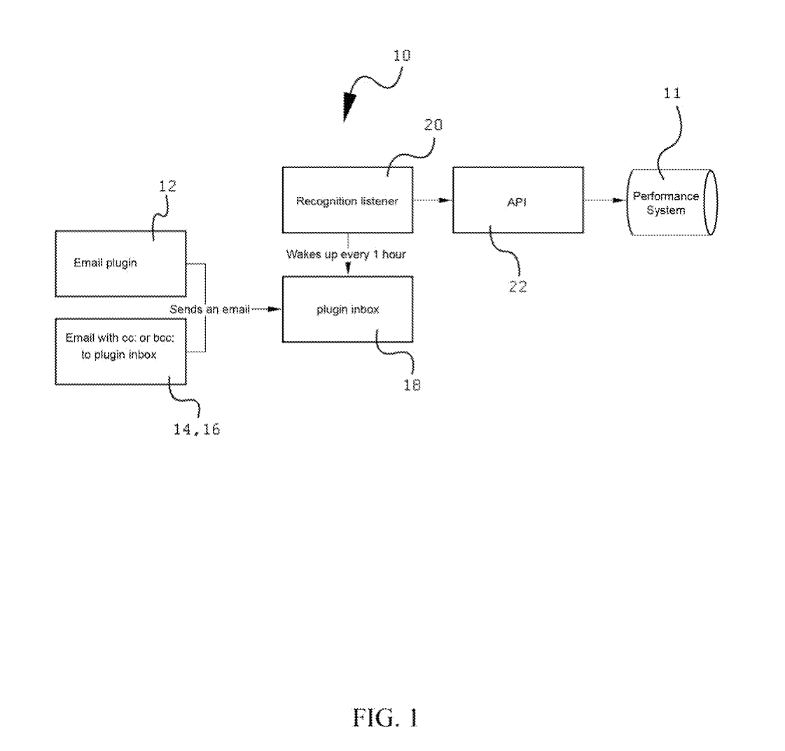

An exemplary high level architecture for a recognition email listener system 10 (hereinafter sometimes “system 10”) of the present invention is shown in FIG. 1. System 10 supplies specific recognition-related data to a performance system 11 for further processing and comprises an email plugin 12 and/or a regular email access through use of an email copy filed such as a CC: field 14 or BCC: field 16, a plugin inbox 18, a recognition listener 20, and an application processing interface (API) 22.

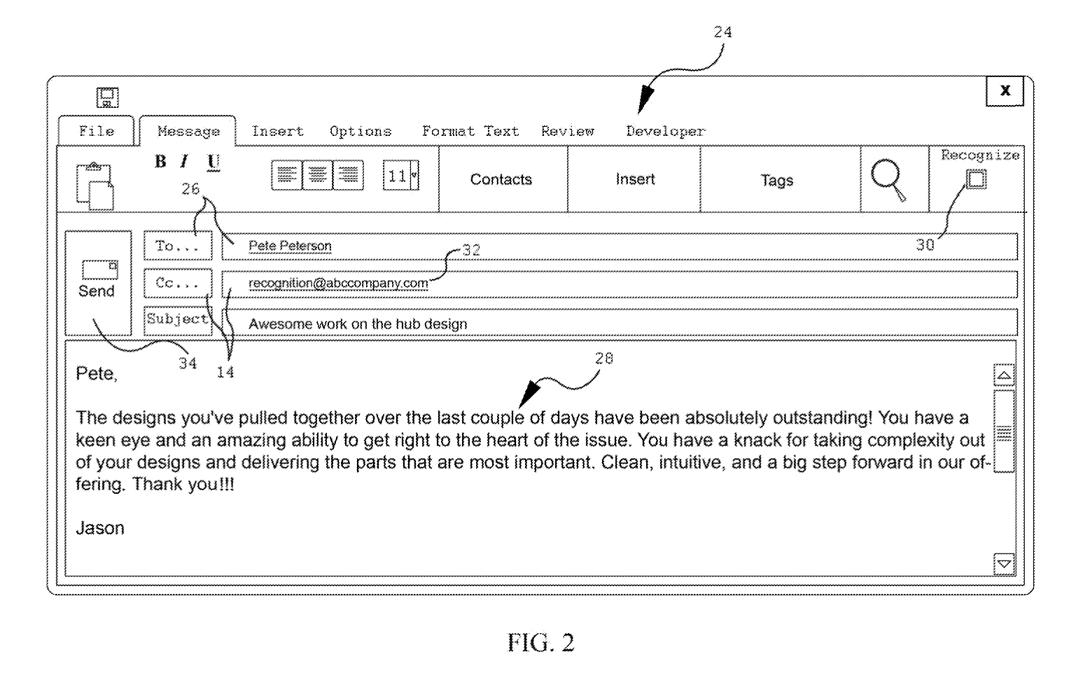

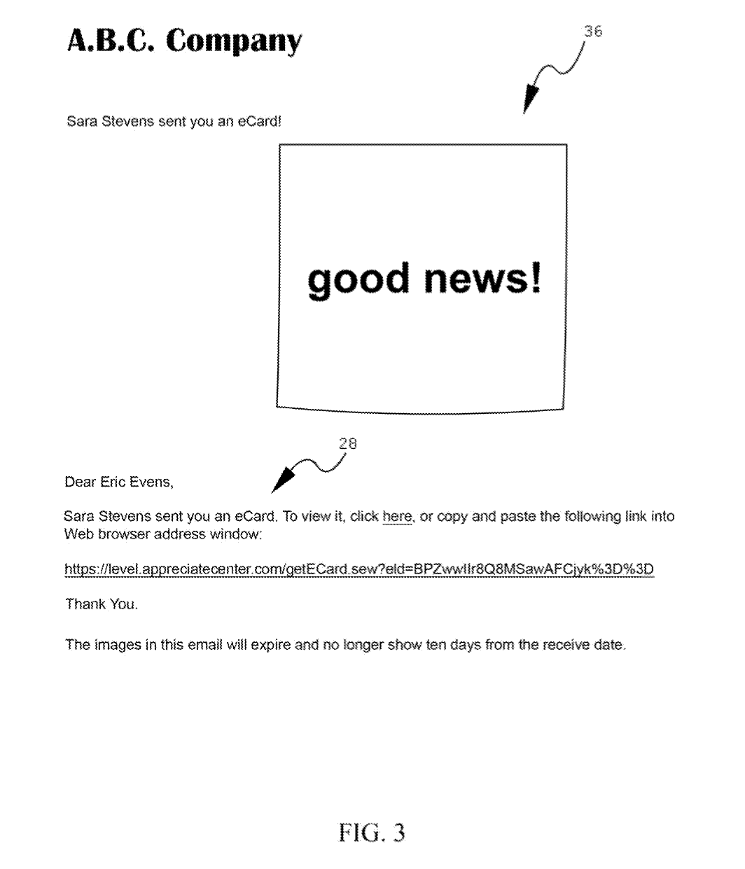

The system 10 utilizes a process that begins by using the email plugin 12 or sending an email to a predetermined mailbox, designated as the plugin inbox 18. The email-sending user prepares a recognition-related email and sends it to the identified recipients, including the plugin inbox 18. An email interface 24 for the email sent has a format (as shown generally, and by way of example, in FIG. 2) as follows:
TO: Email for the recognition recipient. The TO: field 26 could contain multiple email addresses.
CC or BCC: Contains the email address for the plugin inbox 18. The email plugin 12 always uses the BCC: field 16. Additionally, the CC: field 14 and BCC: field 16 may contain email addresses for any other intended recipients.
The body 28 or text of the email that contains a recognition message may be used for further processing.
The email-sending user is the sender of or recognition giver of an email containing recognition content, whether the email is an award nomination, has recognition-related text, is an eCard, or any other form of eButton or eThanks.
If the email is an eCard (see FIG. 3), bravo-map may be used to look up the eCard configuration, and all required components to call the eCard service are prepared so that the eCard can be sent. Alternatively, all of the emails may be saved as Bravo eCards.

If an email plugin 12 is used on the email interface 24, a check box 30, labeled “Recognize” or any other suitable term, is provided. By checking the check box 30, the email plugin 12 an email-user automatically sends the recognition-related email to the plugin inbox 18 where all such emails are accumulated for further processing.

The recognition listener 20 wakes up every one-hour interval of time (or any other suitable period of time) to gather all the emails collected in the plugin inbox 18 for the most recent interval of time. Although a one-hour interval is indicated, it should be understood that the recognition listener feature could be configured with the capability to change that interval.

The recognition listener 20 then calls the API 22 with the names of the recipients collected from the TO: field 26 and the content of the recognition-related email from the body 28 of the email.

Although other similar programs may be used, an in-house java program using a standard java API 22 called javax.mail reads the email. With the aid of this API 22, the program starts a mail session using a standard protocol called imap. Once the email credentials are received, a program within the recognition listener 20 opens the plugin inbox 18, and attaches to two folders. The first folder being an inbox, the other is a processed messages folder (not shown).

The program within the recognition listener 20 then loops through the inbox, determines who is the sender, identifies the recipient or recipients (minus the cc's), grabs the message, and then calls the API 22 to facilitate further processing. The recognition listener also may archive all emails for further troubleshooting.

After the API 22 is called and further processing is complete, the inbox message is then moved from the inbox to the processed messages folder. Ultimately, the system deletes all processed emails in the processed messages folder. A process may be configured to delete the emails in the processed messages folder automatically at a later time.

The API 22 for the performance system 11 guards the access to the platform functionality and database access. Every external request is sent to API 22, which checks for the validity of the request and then executes business logic and ultimately saves the data into a database within the performance system 11.

As shown in FIG. 2, the email plugin 12 to the email program inserts a recognition check box 30 into the email interface 24 presented to an email-sending user. If the email-sending user checks the check box 30 by clicking on the check box 30, the email-sending user is indicating that the content of the email has recognition-related content within the body 26 of the email, such as praising an employee for work well done or, for example, an eButton, or an eCard recognizing an employee's accomplishment is associated with the email. By checking the recognition check box 30, the email plugin 12 automatically adds an address for a predetermined mailbox, the plugin inbox 18 into the BCC: field 16 for the email (not shown, because addresses within the BCC: field 16 are typically not shown unless that filed is selected by the email user). A copy of each of such recognition-related emails is sent to the plugin inbox 18 for further processing.

Alternatively, if the recognition check box 30 is not checked, the email-sending user may send a copy of the recognition-related email to the plugin inbox 18 by adding the address 32 for the plugin inbox 18 into the CC: field 14 (or the BCC: field 16) for the email.

When the email-sending user clicks on the send button 34, copies of the email are sent to each recipient whose address is in the TO: field 26, the CC: field 14, and the BCC: field 16 (not shown in FIG. 2).

Any type of recognition-related email, such as nominations for recognition, eCards, eButtons, etc. may be forwarded for further processing. An example of an eCard 36 as would be received via email by a recipient employee is shown in FIG. 3. If the recognition box 30 was checked or the address 32 for the plugin inbox 18 was added to the CC: field 14 (or the BCC: field 16) by the email-sending user, a copy of this eCard 34 would be sent directly to the plugin inbox 18.

In this manner, seamless integration of the backend processing of the recognition-related information into the most commonly used tool by many companies, Outlook® or any other email system, is provided. Further, it is a reliable mechanism to place recognition-related email transactions into the performance system 11 to provide metrics for evaluation of employee and/or team performance. Additionally, the email plugin 12 is configured secure so that it does not pose a security threat for the user company, and it is easy to install and configure.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A system for facilitating employee recognition and the analysis of performance indicators for the evaluation of employee performance for users of email software, the system for providing recognition-related data to a recognition software platform that accumulates, categorizes, and presents recognition-related data for performance evaluation, comprising:
a recognition listener feature comprising means for sending recognition-related content in an email to a predetermined mailbox, said means for sending recognition-related content being selected from at least one of a plugin to a specific email address for the email software to direct emails being sent by an email-sending user having recognition-related content into the predetermined mailbox and insertion of a specific email address into an email copy filed for the email software to direct emails being sent by an email-sending user having recognition-related content into the predetermined mailbox;
a recognition listener that periodically loops through the emails within the predetermined mailbox to gather and determine desired information, the desired information comprises the identity of an email-sending user for each email in the predetermined mailbox, the identity of each recipient for each email in the predetermined mailbox, and the textual content for each email in the predetermined mailbox; and
an application processing interface is called by the recognition listener to facilitate further processing of the desired information.

2. A system as set forth in claim 1 wherein each email is sent to a processed message folder after it has been processed by the recognition software platform.

3. A system as set forth in claim 1 wherein the application processing interface that at least in part guards access to the recognition database.

4. A system as set forth in claim 1 wherein the email software has an email interface and the plugin provides a check box on the email interface, by checking the check box the email-sending user automatically adds the specific email address for the predetermined mailbox to the bcc field of the email interface.

5. A system as set forth in claim 1 wherein the recognition-related content in an email is selected from the group consisting of a textual email, an eCard, an eButton, an award nomination, and any combination thereof.

6. A system for facilitating employee recognition and the analysis of performance indicators for the evaluation of employee performance for users of email software, comprising:
a recognition listener feature that utilizes a plugin to a specific email address for the email software to direct emails being sent by an email-sending user having recognition-related content into a predetermined mailbox;
a recognition listener that periodically loops through the emails within the predetermined mailbox to gather and determine desired information, the desired information comprises the identity of an email-sending user for each email in the predetermined mailbox, the identity of each recipient for each email in the predetermined mailbox, and the textual content for each email in the predetermined mailbox, the recognition listener calls an application processing interface to facilitate further processing of the desired information; and
a recognition software platform that processes the desired information by accumulating, categorizing, and presenting the desired information as processed.

7. A system as set forth in claim 6 wherein each email is sent to a processed message folder after it has been processed by the recognition software platform.

8. A system as set forth in claim 6 wherein the recognition software platform has a recognition database for storing the desired information as processed and an application processing interface that at least in part guards access to the recognition database.

9. A system as set forth in claim 6 wherein the plugin provides a check box on an email interface, by checking the check box the email-sending user automatically adds the specific email address for the predetermined mailbox to the bcc field of the email interface.

10. A system as set forth in claim 6 wherein the recognition-related content in an email is selected from the group consisting of a textual email, an eCard, an eButton, an award nomination, and any combination thereof.

11. A method for facilitating employee recognition and the analysis of performance indicators for the evaluation of employee performance for users of email software, the method for providing recognition-related data to a recognition software platform that accumulates, categorizes, and presents recognition-related data for performance evaluation, comprising the steps of:
providing a recognition listener feature comprising means for sending recognition-related content in an email to a predetermined mailbox, said means for sending recognition-related content being selected from at least one of an email plugin to a specific email address for the email software to direct emails being sent by an email-sending user having recognition-related content into the predetermined mailbox and insertion of a specific email address into an email copy filed for the email software to direct emails being sent by an email-sending user having recognition-related content into the predetermined mailbox;
sending recognition-related content via email to the predetermined mailbox;
providing a recognition listener that periodically loops through the emails within the predetermined mailbox to gather and determine desired information;
determining the desired information comprising the steps of:
identifying the email-sending user for each email in the predetermined mailbox;
identifying each recipient for each email in the predetermined mailbox, and
collecting the textual content for each email in the predetermined mailbox; and
calling an application processing interface facilitate further processing of the desired information.

12. A method as set forth in claim 11 further comprising the step of sending each email a processed message folder after it has been processed by the recognition software platform.

13. A method as set forth in claim 11 wherein the application processing interface performs the step of guarding access to the recognition software platform.

14. A method as set forth in claim 11 further comprising the step of providing a check box on an email interface as part of the email plugin.

15. A method as set forth in claim 14 further comprising the step checking the check box to automatically add the specific email address for the predetermined mailbox to the bcc field of the email interface.

16. A method as set forth in claim 11 wherein the recognition-related content in an email is selected from the group consisting of a textual email, an eCard, an eButton, an award nomination, and any combination thereof.

17. A system as set forth in claim 11 further comprising the step of selecting the recognition-related content in an email from the group consisting of a textual email, an eCard, an eButton, an award nomination, and any combination thereof.
